(19) United States
(12) Patent Application Publication
(10) Pub. No.: US 2021/0314677 A1
(43) Pub. Date: Oct. 7, 2021

(54) Remote Meteorological Sensing via Aircraft Mode Selective Enhanced Surveillance

(71) Applicant: Massachusetts Institute of Technology, Cambridge, MA (US)

(72) Inventor: Michael D. McPartland, Westford, MA (US)

(21) Appl. No.: 17/033,339

(22) Filed: Sep. 25, 2020

Related U.S. Application Data
(60) Provisional application No. 62/908,018, filed on Sep. 30, 2019.

(51) Int. Cl. H04Q 9/00; H04W 4/44; H04B 7/185; G01W 1/08; G01W 1/02

(52) U.S. Cl. CPC H04Q 9/00; H04W 4/44; H04B 7/18506; G01W 2001/003; G01W 1/02; H04Q 2209/40; G01W 1/08

(57) ABSTRACT

Embodiments provide functionality to remotely observe atmospheric conditions. An embodiment, in response to receiving an indication of existence of an airborne aircraft, automatically selects an antenna from a plurality of fixed antennas based on a location and an orientation of each antenna of the plurality of fixed antennas. In turn, a request for data is sent to the aircraft using the selected antenna and, in response to the request, data is received from the aircraft. The data received from the aircraft is automatically processed in a manner determining an atmospheric condition.

### RELATED APPLICATION

This application claims the benefit of U.S. Provisional Application No. 62/908,018, filed on Sep. 30, 2019. The entire teachings of the above application are incorporated herein by reference.

### GOVERNMENT SUPPORT

This invention was made with Government support under Grant No.: FA8702-15-D-0001 awarded by the U.S. Air Force. The Government has certain rights in the invention.

### BACKGROUND

Existing methods for meteorological sensing rely on weather balloons, which collect data infrequently and are sparsely deployed. Other methods for meteorological sensing rely on specially equipped aircraft. Further methods include ground based radar stations.

### SUMMARY

The atmosphere is sparsely sampled both spatially and temporally using existing techniques, such as by weather balloons and by specialty equipped aircraft. Numerical/gridded weather forecast models need an estimate of the atmospheric conditions, such as temperature, humidity, and wind from the surface to high altitudes to run models and make a reasonable weather forecast. Weather radar, for example, cannot offer any of these data when there is no precipitation in the atmosphere to reflect a radar signal. Weather radar does not measure or sample in situ but rather measures reflections in the atmosphere (e.g., from precipitation or other reflective particles) and weather estimates can be calculated from this data. Currently weather balloons sample in situ, but these are typically done only twice a day and in extremely limited locations. Therefore, the vast majority of the atmospheric volume lacks in situ sampling of conditions.

Embodiments of the present disclosure solves the problem of sparse in situ sampling by determining atmospheric conditions (e.g., wind and temperature) from aircraft data using standalone, (e.g., portable) functionality that is not constrained by current secondary surveillance radar (SSR) systems. Embodiments can make wind and temperature estimates using data obtained from commercial, executive, and private aircraft across all altitudes and large regions to help initialize forecast models, among other uses.

The atmospheric conditions determined by embodiments of the present disclosure can improve weather forecasts and provide important data to air traffic control and military decision makers.

In an embodiment, a computer-implemented method and corresponding system for remotely observing an atmospheric condition, include, in response to receiving, at a plurality of fixed antennas, an indication of existence of an airborne aircraft, automatically selecting an antenna from the plurality of fixed antennas based on a location and an orientation of each antenna of the plurality of fixed antennas. The method further includes using the selected antenna, sending to the aircraft a request for data. The method further includes receiving data, at the selected antenna, from the aircraft in response to the request, the data gathered by sensors of the aircraft. The method further includes automatically determining the atmospheric condition based on the data received from the aircraft.

In an embodiment, the atmospheric condition is at least one of wind speed, wind direction, turbulence, and temperature.

In an embodiment, the data received from the aircraft includes at least one of: magnetic orientation of the aircraft, true air speed of the aircraft, ground speed of the aircraft, vertical speed of the aircraft, location of the aircraft, Mach of the aircraft, and track of the aircraft. In another embodiment, the data received from the aircraft can include at least two of: magnetic orientation of the aircraft, true air speed of the aircraft, ground speed of the aircraft, vertical speed of the aircraft, location of the aircraft, Mach of the aircraft, and track of the aircraft.

In an embodiment, the method includes, at each fixed antenna, receiving a plurality of messages from one or more aircrafts, wherein the received messages include aircraft location information. The method further includes determining an intensity of each of the plurality of received messages at each of the fixed antennas. The method further includes determining the orientation of each of the fixed antennas based on the location information, a location of the fixed antennas, and the determined intensity of each message of the plurality of received messages at each of the fixed antennas.

In an embodiment, a method includes receiving from a sensor the indication of existence of the aircraft.

In an embodiment, method further includes associating the atmospheric condition with a location of the aircraft with the indication of existence. In a further embodiment, associating the atmospheric condition with the location further includes associating a plurality of atmospheric conditions with respective locations, and the method further includes storing each of the plurality of atmospheric conditions and respective locations in a database.

In an embodiment, selecting the antenna further includes determining an antenna pointing at the aircraft based on a location of the aircraft, an orientation of the plurality of fixed antenna, and a location of the plurality of fixed antenna.

Another embodiment is directed to a system for remotely observing an atmospheric condition that includes a processor and a memory with computer code instructions stored thereon. In such an embodiment, the processor and the memory, with the computer code instructions, are configured to cause the system to implement any embodiments described herein.

Yet another embodiment is directed to a computer program product for remotely observing an atmospheric condition. The computer program product comprises a computer-readable medium with computer code instructions stored thereon where, the computer code instructions, when executed by a processor, cause an apparatus associated with the processor to perform any embodiments described herein.

Another embodiment is directed to a method for determining orientation of an antenna in a plurality of fixed antennas in an environment. Such an embodiment includes initializing a location of the plurality of fixed antennas in the environment. At each antenna of a plurality of fixed antennas deployed in an environment, the method receives a plurality of messages at least one message from one or more aircraft in response to one or more requests for data, the messages indicating location information for the one or more aircrafts Then, the method determining an intensity of each of the plurality of received messages at each of the fixed antennas. Then the method determining an orientation of each of the fixed antennas relative to the environment based on the location information for the one or more aircraft, the location of the plurality of fixed antennas, and the determined intensity of each message of the plurality of received messages at each of the fixed antennas.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIGS. 1A and 1B are two plots showing data determined using an existing method and data determined using embodiments.

FIG. 2 is a diagram illustrating an example embodiment of a system employing the present disclosure.

FIG. 3 is a diagram illustrating an example embodiment of the present system having multiple aircraft.

FIG. 4 is a diagram illustrating an example embodiment of the present disclosure.

FIG. 5 is a flow diagram illustrating an example embodiment of the present disclosure.

FIG. 6 is a flow diagram illustrating an example embodiment of a method employed by the present disclosure.

FIG. 7 is a diagram illustrating an example embodiment of the present disclosure.

FIG. 8 illustrates a computer network or similar digital processing environment in which embodiments of the present disclosure may be implemented.

FIG. 9 is a diagram of an example internal structure of a computer (e.g., client processor/device or server computers) in the computer system of FIG. 8.

### DETAILED DESCRIPTION

A description of example embodiments follows.

In an embodiment, the present disclosure employs data from aircrafts to determine atmospheric conditions. One such embodiment leverages the inherent capabilities of Mode Selective (Mode S) and Mode Selective Enhanced Surveillance (Mode S EHS) transponders installed on aircraft. Mode S EHS transponders, however, are better suited to this role as they automatically populate data registers of interest relative to weather estimation, where Mode S transponders may populate those registers. Mode S and Mode S EHS systems by design automatically broadcast a response message to an interrogation from an external system. This information in the response can include a call sign or tail number of the aircraft, current altitude and the contents of data registers of interest. From the response, distance from the external system can be calculated using the time of flight of the message. The azimuth of the aircraft is not in this message, but can be calculated in certain circumstances. The system then requests information from the aircraft, and that information can be used to calculate wind and temperature at the aircraft's location. A minority of aircraft store wind and temperature in a register and the system can ask for that directly.

In an embodiment, the method listens (e.g., on 1090 MHz) for squitter messages repeatedly transmitted at about one per second by both Mode S transponder types. A person having ordinary skill in the art can recognize that squitter messages in Mode S systems describe unsolicited downlink transmissions from the aircraft. Such an embodiment maintains a record of recent Mode S addresses received. If the address is not in the current record, the embodiment sends an uplinked formatted message (e.g., UF4 or UF5) on an omni or directional antenna on 1030 MHz to interrogate the transponder's register 0x17 for that system's (the system sending the squitter messages) capabilities.

Mode S messages can interrogate the transponder for information in specific registers, including a list of serviced registers. According to an embodiment, if the interrogated transponder indicates that it populates the data registers of interest, then the aircraft is intelligently interrogated based on the current system needs (e.g., the data needed to determine atmospheric conditions). If a transponder is capable of populating the data associated with registers of interest (registers storing data that can be used to determine atmospheric conditions, including registers 0x50 and 0x60) then a listener system obtains the register data and a processing system can then determine atmospheric conditions (e.g., wind and the ambient air temperature).

In an embodiment, wind is estimated as a function of reported ground speed, true airspeed, true heading, and track angle where true heading is typically estimated as a function of reported magnetic heading, the aircrafts current position, and time. A person having ordinary skill in the art can calculate the wind speed using wind triangle calculations that are known in the art. Further, according to an embodiment, temperature is determined as a function of reported Mach and true airspeed. The temperature can be determined according to the following relationships:

M=v_{TAS}/a,

where M is Mach, V_{TAS} is true airspeed, and a is the speed of sound,

a=V_{TAS}/M,

a=\sqrt{γ*R*T},

Where γ is an adiabatic constant known to a person having ordinary skill in the art and R is a gas constant known to a person having ordinary skill in the art

$$T = {( \frac{{V}_{TAS}}{M} )}^{2} \text{/} ( γ * R )$$

According to yet another embodiment, if, in addition, register 0x53 is also available, then both the temperature and wind can be estimated with much finer resolution. These and the contents of other data registers may be used to estimate other weather conditions such as turbulence.

A unique element of an embodiment is that the interrogations are conducted from a standalone, non-rotating antenna. Herein, the terms non-rotating and fixed may be used interchangeably. Further, it is noted that in embodiments, while the term fixed may be used, fixed indicates that the antenna is not rotating, however the antenna may be on or coupled to a moving object such as a car or aircraft. In other words, the term fixed used herein is defined as fixed rotationally, or stationary rotationally relative to the object to which they are attached, whether the object is moving or stationary. In embodiments, a fixed antenna can be an omni directional antenna. In other embodiments, a fixed antenna can be a directional antenna. In further embodiments, a fixed antenna can be a plurality of directional antennas. In an even further embodiment, the fixed antenna can be one or more directional antennas used in conjunction with an omnidirectional antenna.

In current systems, Mode S and Mode S EHS transponders are interrogated by a rotating antenna having a radar fence. Rotating antenna have the advantage of being able to focus on a specific direction, and can therefore transmit all of its energy in that same direction. This can result in increased range and reduce interference that may result in interrogations broadcast in multiple directions simultaneously. However, such rotating antenna also bring drawbacks. For example, messages in general can only be successfully sent and received while the rotating antenna is facing the target. Therefore, a rotating antenna can therefore only communicate with a particular aircraft during the time it is facing that aircraft.

In an embodiment, a rotationally fixed antenna solves the above problems by sending and receiving messages in all directions simultaneously, whether it is from an array of directional antennas or an omnidirectional antenna. This allows for more frequent sampling of data from aircraft to give a more robust atmospheric information set. In one embodiment, multiple directional antennas are employed with an omni directional antenna, where the omni directional antenna can send and receive messages from nearby aircraft (e.g., within 5-10 miles) and the directional antennas reach aircraft that are further away. In other embodiments, a phased array antenna can be used.

For example, a system embodiment can be deployed on a moving aircraft, manned or unmanned, e.g., UAV/drone, but the system simply does not rotate. In such an embodiment, the present method and system can be used to interrogate other aircraft, such as an aircraft in front of the aircraft including the transponders described above (e.g., transponders of a Mode S system). In an embodiment, the system can be used during flight to modify operation of the aircraft. For example, prior to or during descent, an aircraft utilizing the system can interrogate other aircrafts to determine atmospheric conditions and implement a more optimal descent using the determined estimate of atmospheric conditions (e.g., winds). Such functionality is operationally useful in terms of both adhering to any timing/schedule constraints and in fuel savings. Further, embodiments may utilize the same frequencies for communications as Traffic Alert and Collision Avoidance Systems (TCAS), but request different data as described herein.

In an embodiment, the present disclosure enables an aircraft/transponder to be interrogated from locations and at update rates tailored to the needs of the end user without modifications to existing legacy infrastructure, such as the SSR network. For example, a proposed system embodiment can interrogate aircraft in a dedicated region and at rates on the order of 1 Hz. In comparison, interrogations of aircraft transponders that use rotating airport SSRs or long-range SSRs are limited to about 0.2 Hz and 0.08 Hz respectively.

Another standard way to obtain observations of atmospheric conditions is from commercial aircraft that participate in the Meteorological Data Collection and Reporting System (MDCRS). However, only about 20% of commercial aircraft participate, typically with coarse 1-7 minute sampling periods, and latent reporting (17 minutes delay on average). In contrast, embodiments of the present disclosure can report meaningful estimates of conditions at often as every 1.3 seconds for each aircraft and in near real-time. The present disclosure can update every 1.3 seconds due to the rate of update of data on the registers of interest on the aircraft, however, if an aircraft were to update the registers faster, the condition estimates could be updated faster than ever 1.3 seconds.

Experimental data demonstrating the interrogation techniques of embodiments, and wind and temperature estimates determined as described herein, have been obtained in operational demonstrations using a modified SSR.

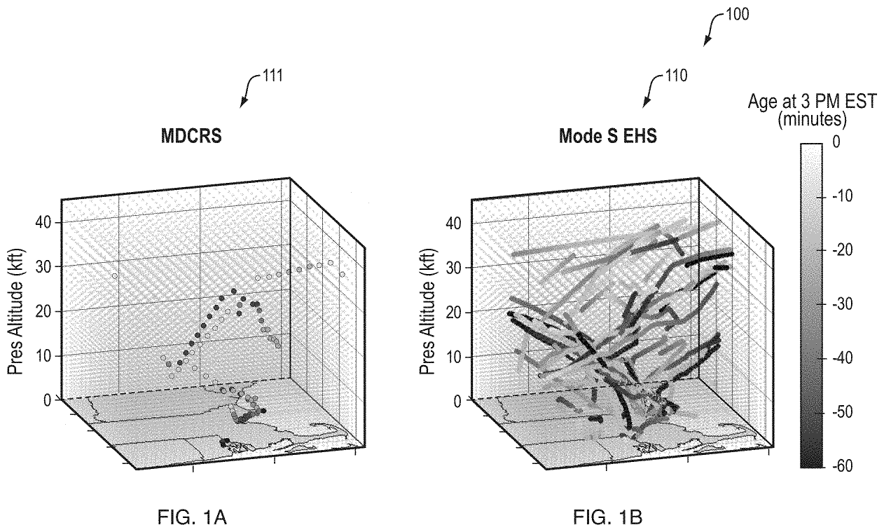

FIGS. 1A and 1B are respective plots 110 and 111 illustrating the difference in data obtained using embodiments of the present disclosure and prior methods. Plot 110 illustrates data collected based on the modified SSR experiments compared to the data obtained using existing MDCRS functionality. Plot 111 illustrates data collected from a sample period of flights around Massachusetts using current methods. FIGS. 1A and 1B illustrate a comparison between the atmospherics observations that can be provided using existing technology (plot 111) and the atmospheric observations that can be determined using embodiments (plot 110). A person having ordinary skill in the art can recognize the data retrieved by the present disclosure in plot 110 are far more robust, as data is collected from flights more often and from more flights.

While altitude can be reported and range to the reporting transponder/aircraft can be estimated by an embodiment, employing more precise position (e.g., latitude and longitude) estimates can add value to the data estimate. In such an embodiment, the associated positions (e.g., latitude and longitude) can be supplied by primary or secondary surveillance radars, Automatic Dependent Surveillance-Broadcast (ADS-B), or by using a plurality of interrogation systems which are connected in such a fashion that they are communicating with each other, permitting position estimation via multilateration. A person having ordinary skill in the art can recognize that multilateration is a method of determining position of an object based on times of arrival of propagating waves having a known speed.

Embodiments can employ multiple quality control and validation techniques to improve the determined atmospheric conditions and positional estimates that are utilized. For example, embodiments can perform validation for reasonable values of reported data, identify “stuck” reported values, and compensate or invalidate data as a function of reported speed. Further, embodiments can be employed by entities, e.g., the Air Force, NOAA/NWS, FAA, and air carriers, amongst other examples, to determine flight conditions and to modify aircraft operations, such as flight paths.

An example embodiment is directed to a computer-implemented method for remotely observing an atmospheric condition. Such a method, in response to receiving an indication of existence of an airborne aircraft, automatically selects an antenna from a plurality of fixed antennas based on a location and an orientation of each antenna of the plurality of fixed antennas. The method continues by using the selected antenna to send a request for data to the aircraft. In turn, data is received from the aircraft in response to the request and the data received from the aircraft is automatically processed in a manner determining an atmospheric condition. In an embodiment, the data received from the aircraft is processed in known ways to determine the atmospheric condition.

In embodiments, the atmospheric condition is at least one of: wind speed, wind direction, turbulence, and temperature. Further, according to an embodiment, the data received from the aircraft includes at least one of: magnetic orientation of the aircraft, true air speed of the aircraft, ground speed of the aircraft, vertical speed of the aircraft, location of the aircraft, Mach of the aircraft, and track of the aircraft. In an example embodiment, magnetic orientation of the aircraft, true air speed of the aircraft, track of the aircraft, and ground speed of the aircraft are processed to determine wind atmospheric conditions. Further, according to an embodiment, the data received from the aircraft includes at least two of: magnetic orientation of the aircraft, true air speed of the aircraft, ground speed of the aircraft, vertical speed of the aircraft, location of the aircraft, Mach of the aircraft, and track of the aircraft. In an example embodiment, magnetic orientation of the aircraft, true air speed of the aircraft, track of the aircraft, and ground speed of the aircraft are processed to determine wind atmospheric conditions.

In embodiments, the location of the aircraft at the time the requested data is received can also be used in determining wind atmospheric conditions. An estimate of the data source's location (e.g., the aircraft) is employed to change the magnetic orientation to a true orientation (e.g., the orientation relative to truth north as opposed to magnetic north) to make the estimate of the wind. That location estimate can be precise, such as using the location published by the aircraft itself (ADS-B messages) or imprecise, such as using the general location of the receiving antenna (which is typically known) to make the estimate. The more precise the estimate of the location of the subject of interest, the more accurate the wind estimate. Further, another embodiment utilizes vertical speed of the aircraft to improve the determined wind atmospheric condition. In another embodiment, true air speed of the aircraft and Mach of the aircraft are processed to determine temperature.

Yet another embodiment includes receiving from a sensor the indication of existence of the aircraft.

Another embodiment determines the orientation of each antenna of the plurality of fixed antennas. Such functionality can be employed when the orientation of the antennas is not known. In such an embodiment, at each fixed antenna, a plurality of messages from one or more aircrafts are received, wherein the received messages include aircraft location information. The plurality of messages may be any messages sent from an aircraft. Further, it is noted that in an alternative embodiment, the plurality of received messages do not include aircraft location information and the aircraft location information is determined in another way. To continue, intensity of each of the plurality of received messages at each of the fixed antennas is determined. According to an embodiment, “intensity” is magnitude of the received signal as measured at the receiving antenna. In turn, the orientation of each of the fixed antennas is determined based on the location information and the determined intensity of each message of the plurality of received messages at each of the fixed antennas.

Another embodiment is directed to a method for determining orientation of an antenna in a plurality of fixed antennas in an environment. Such an embodiment includes deploying a plurality of fixed antennas in an environment and, at each antenna of the plurality of fixed antennas, receiving a plurality of messages from one or more aircrafts in response to one or more requests for data. To continue, data indicating location information for the one or more aircrafts is received and an intensity of each of the plurality of received messages at each of the fixed antennas is determined. In an embodiment, the “location information” may include two-dimensional (2D) location information and may also include altitude. Such an embodiment then determines orientation of each of the fixed antennas based on the location information and the determined intensity of each message of the plurality of received messages at each of the fixed antennas. In such an embodiment, the location information of the aircraft/target can be received by other means/antennae, such as by a separate ADS-B receiving radio.

Further, it is noted that while the aforementioned embodiment is described as receiving a plurality of messages and determining orientation based on intensity of each message of the plurality of received messages, embodiments are not so limited. For instance, in another embodiment, a single response is used to determine the approximate orientation of an antenna of the plurality, by determining, e.g., measuring, the intensity of the response on each antenna. In such an embodiment, orientation of an antenna is determined based upon the determined intensities of the message at the plurality of antennas. Such an embodiment may implement such functionality using a receiving radio for each antenna. However, another embodiment may use a single radio with a switch to select which antenna to use and, thus, in such an embodiment, a plurality of messages are used to estimate the orientation of each antenna.

It is noted that while embodiments are described herein as using a plurality of fixed antennas, embodiments are not so limited and embodiments may determine atmospheric conditions using a single fixed, e.g., non-rotating, antenna. In such an embodiment, the single antenna is used to send a request for data to an aircraft and, in turn, data is received from the aircraft in response to the request. This data received from the aircraft is then automatically processed in a manner determining an atmospheric condition.

Embodiments can be implemented in portable systems that can sample atmospheric conditions from aircrafts within range of the system, e.g., 100 miles. Embodiments can be deployed in any variety of environments and locations. Further, embodiments can provide data in near real-time time over cellular or satellite communications networks, amongst other examples, to consumers who want the data for their products or operations.

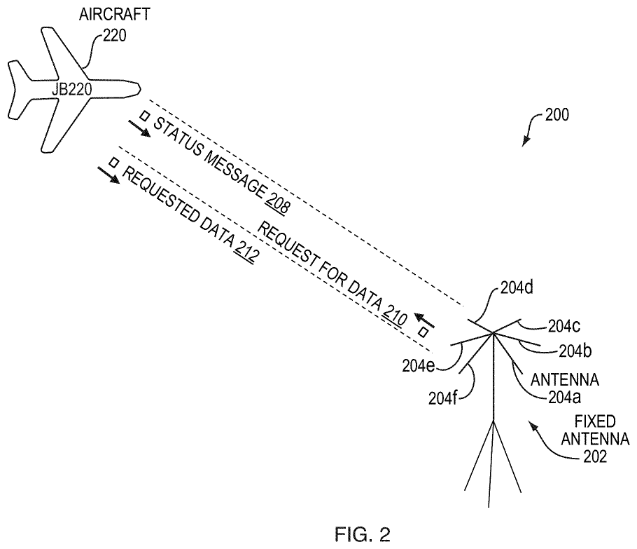

FIG. 2 is a diagram illustrating an example embodiment of a system employing the present disclosure. A fixed antenna 202 is configured with a processor and a radio to communicate with a transponder (not shown) of an aircraft 220. A person having ordinary skill in the art can recognize that in the description throughout, that the fixed antenna 202 sends signals and processes signals using the processor and radio. The aircraft 220 broadcasts ADS-B messages 208 that identifies the aircraft (e.g., via a 24-bit address) and provides its location. After receiving the ADS-B messages 208, the system selects an antenna 204a-f that is determined to be pointing to the aircraft 220 using the location of the fixed antenna 202, location of the aircraft from the ADS-B messages 208, and an orientation of the fixed antenna 202. In the example of FIG. 2, the antenna selected is antenna 204e. After receiving the ADS-B messages 208, the selected antenna 204e periodically sends a request for data 210, which requests data stored in registers of the aircraft 220. The fixed antenna 202 can send requests for data 210 periodically until, for example, the aircraft 220 is out of range. Then, the same antenna 204e receives the requested data 212 (e.g., data from the registers of the aircraft). The requested data 212, once received, can be used to estimate atmospheric conditions.

The following is a listing of data that the system may collect from aircraft. At a minimum, the data needed to estimate wind if presuming straight and level horizontal flight includes true airspeed, magnetic heading, true track angle, and ground speed. Truck track angle and groundspeed can be estimated from position reports. Local magnetic deviation is needed to obtain a true heading. Other data can enhance the calculation of atmospheric conditions. These data and the respective register that store them are the following. Register 0x50 stores roll angle, true track angle, ground speed, track angle rate, and true airspeed. Register 0x53 stores magnetic heading, indicated airspeed, Mach number, true airspeed, and altitude rate. Register 0x60 stores magnetic heading, indicated airspeed, Mach number, barometric altitude rate, and inertial vertical velocity. Register 0x44 includes wind speed, wind direction, static air temperature, average static air temperature, turbulence, and humidity. Register 0x45 includes turbulence, wind shear, microburst, icing, wake vortex, static air temperature, average static air temperature, average static pressure, and radio height.

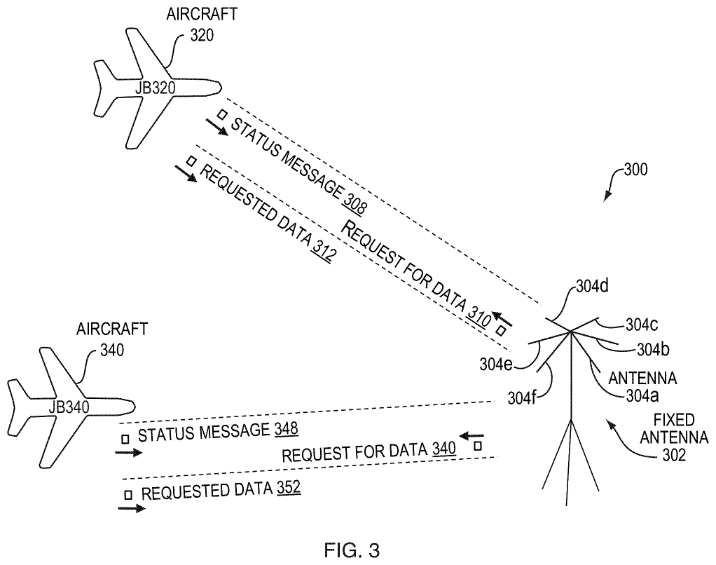

FIG. 3 is a diagram 300 illustrating an example embodiment of the present system having multiple aircraft 320 and 340. A fixed antenna 302 is configured with a processor and a radio to communicate with a transponder (not shown) of an aircraft 320. A person having ordinary skill in the art can recognize that in the description throughout, that the fixed antenna 302 sends signals and processes signals using the processor and radio. The aircraft 320 broadcasts ADS-B messages 308 that include its location (latitude and longitude) and identifies the aircraft. After receiving the ADS-B messages 308, the system selects an antenna 304a-f that is determined to be pointing to the aircraft 320 using the location of the fixed antenna 302, location of the aircraft from the ADS-B messages 308, and an orientation of the fixed antenna 202. In the example of FIG. 3, the antenna selected is antenna 304e. In addition, after receiving the ASD-B messages 308, the fixed antenna 302 periodically sends a request for data 310, which requests atmospheric data measured by the aircraft 320. The fixed antenna 302 can send requests for data 310 periodically until, for example, the aircraft 320 is out of range. Then, the same antenna 304e receives the requested data 310.

A second aircraft 340 operates similar with respect to the fixed antenna 302. The aircraft 340 broadcasts ADS-B messages 348 that includes its location (latitude and longitude) and identifies the aircraft. After receiving the ADS-B messages 348, the system selects an antenna 304a-f that is determined to be pointing to the second aircraft 340 using the location of the fixed antenna 302, location of the aircraft from the ADS-B messages 308, and an orientation of the fixed antenna 302. In the example of FIG. 3, the antenna selected is antenna 304f In addition, after receiving the ADS-B messages 348, the selected antenna 304f periodically sends a request for data 340, which requests data measured by the aircraft 340 as described above. To further advance the system, however, the multiple instances of requested data 312 and 352 should be processed and organized. After processing, the requested data can be converted into data representing atmospheric conditions.

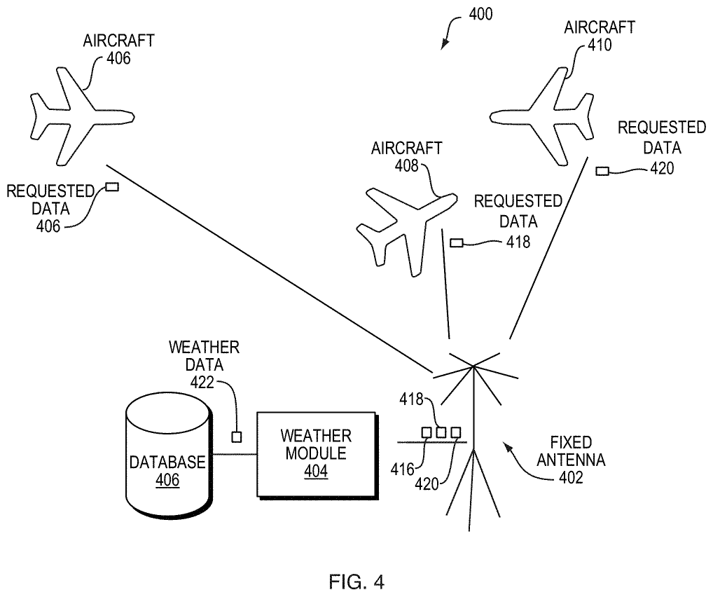

FIG. 4 is a diagram 400 illustrating an example embodiment of the present disclosure. Multiple aircraft 406, 408, and 410 send requested data 416, 418, and 420 to selected antennas of the fixed antenna 402, in a manner described in relation to FIGS. 2-3. For simplicity, the specific data exchange is not described in relation to the current FIG. 4. A person having ordinary skill in the art can understand that the requested data 416, 418, and 420 can be received multiple times from each aircraft at different points of time and therefore from different locations. The fixed antenna 402 sends the requested data 416, 418, and 420 to the weather module 404, which processes the data. The processing includes correlating each respective data to a time and location, converting the data to weather data using known laws of physics (e.g., conversions to temperature, wind speed, pressure, etc.) and outputting that as weather data 422. The weather data 422 can be stored in a database 406 that can be keyed to time, location, condition, or both. The weather data 422 can also be published in real time, for example using a messaging architecture such as pub-sub.

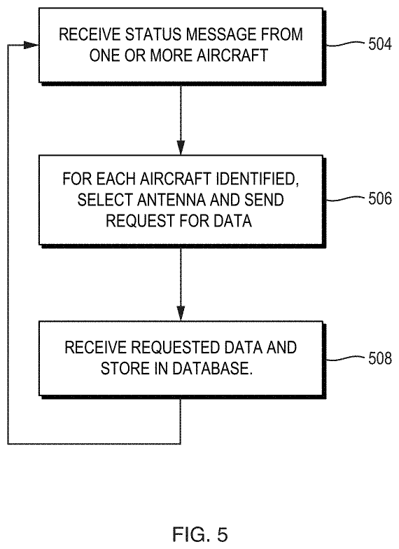

FIG. 5 is a flow diagram 500 illustrating an example embodiment of the present disclosure. The fixed antenna receives ADS-B message(s) of one or more aircraft (504). For each aircraft identified, the fixed antenna then sends a request for data (506). When the aircraft reply, a processor coupled with the fixed antenna stores and processes the requested data (508). The method then can request the data again from the identified aircraft at another timestamp, either in response to another ADS-B message or on a fixed schedule (506).

Table 1 below illustrates example results that can be calculated by the present system. While the database can be sorted in ways known to a person having ordinary skill in the art, Table 1 is one embodiment of such a sorting. Data from several aircraft is reported on a continuous basis and stored in the table, including the aircrafts location, time or recordation, and other data measured by the aircraft. These data can be correlated to windspeed, temperature, and pressure. From this information, weather conditions can be estimated in real time. A person having ordinary skill in the art can recognize that while a one-second time span is illustrated in

TABLE 1
that the system and method continuously send requests for and
receive back atmospheric data over long time periods.

| | | | | Wind | Tempe- | |
|---|---|---|---|---|---|---|
| Aircraft | Latitude | Longitude | Time | speed | rature | Pressure |
| JB230 | 44′55″ | 42′24″ | 12:30:00 | 20 mph | −60 F | 3.3 psi |
| AA762 | 42′53″ | 43′57″ | 12:30:00 | 20 mph | −65 F | 3.0 psi |
| BA130 | 40′56″ | 44′30″ | 12:30:00 | 25 mph | −55 F | 3.5 psi |
| JB230 | 44′55″ | 42′23″ | 12:30:01 | 20 mph | −61 F | 3.4 psi |
| AA762 | 42′54″ | 43′58″ | 12:30:01 | 20 mph | −66 F | 3.1 psi |
| BA130 | 41′56″ | 44′31″ | 12:30:01 | 26 mph | −54 F | 3.4 psi |

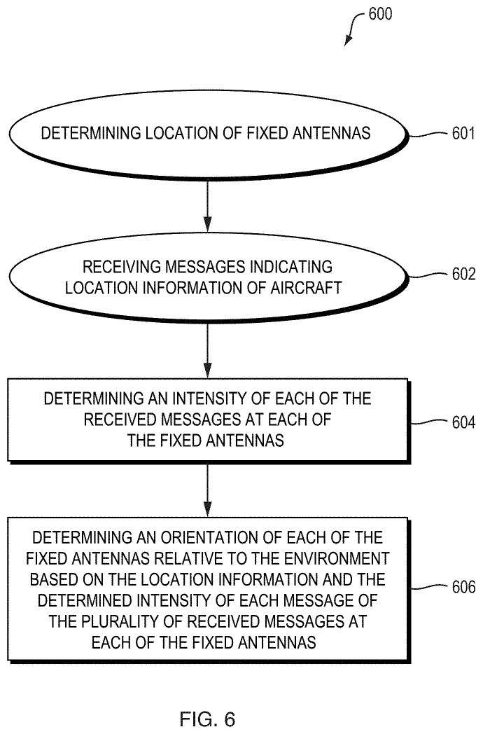

FIG. 6 is a flow diagram illustrating an example embodiment of a method employed by the present disclosure. The method initializes a fixed antenna array by determining the orientation of its individual antennas relative to the environment. In this embodiment, each individual antenna is a directed antenna that is oriented in a particular direction. In embodiments the orientation can be in terms of direction (e.g., North, East, South, West and the varying degrees in between). The method begins by determining the location of the fixed antennas (e.g., latitude and longitude), either by a GPS unit providing the location automatically, a user manually entering in the location (601). Then the method receives messages indicating location information of aircraft from ADS-B message or in a request (602). For each received message, the method then determines the intensity of each message as received at each fixed antenna (604). Then, the method determines, based on the location of the aircraft originating the message and the intensity at each of the fixed antenna an orientation of each fixed antenna (606). This method can be repeated for increased accuracy. This is performed by determining the differences of the intensity received at each fixed antenna to determine the most appropriate antenna to communicate with each aircraft. When this is performed with multiple aircraft at multiple locations, the orientation of each antenna can become more accurate.

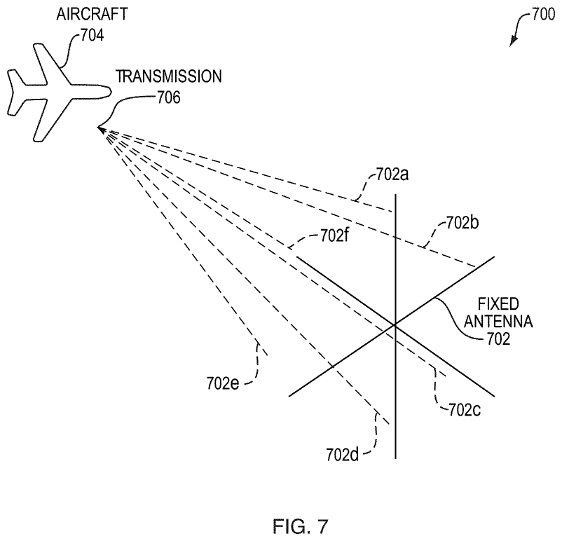

FIG. 7 is a diagram 700 illustrating an example embodiment of the present disclosure. A fixed antenna 702 having multiple identical antennas 702a-f is configured to receive a transmission 706 from an aircraft 704. The fixed antenna 702 is shown from a top-down vertical perspective for illustration purposes. The transmission 706 includes the latitudinal and longitudinal location of the aircraft 704 at the time of transmission. The transmission is received by each of the fixed antenna 702a-f. Each of the fixed antenna 702a-f measure the intensity of the transmission received. The intensity of the transmission 706 is stronger for antenna orientated towards the aircraft 704 and weaker for antenna oriented away from the aircraft 704. Therefore, a person having ordinary skill in the art can recognize that each of the fixed antenna 702a-f measure different intensities of the same transmission 706. Using the knowledge of the locations of each of the fixed antenna 702a-f relative to each other and the starting location of the transmission 706 due to the GPS location of the aircraft 704 being included, a processor can then extrapolate the orientation of the fixed antenna platform 702. The distance and angle between each fixed antenna 702a-f, location of the aircraft 704, and the intensity of the transmission 706 can be factors to calculate the implied orientation of each fixed antenna 702a-e. Therefore, the system can output an orientation of each fixed antenna 702a-e, where the orientation can be a center of the fixed antenna, and the angles of each fixed antenna 702a-f relative to true north or other direction. However, a person having ordinary skill in the art can recognize that orientation can be expressed in other forms that relate the fixed antenna 702a-f to its environment.

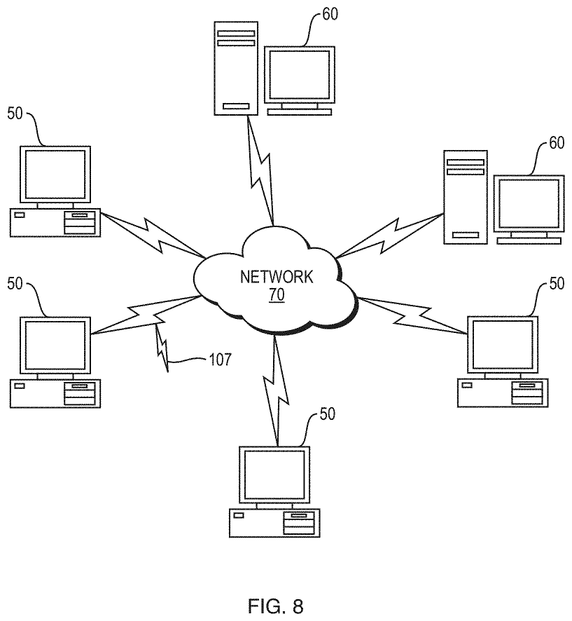

FIG. 8 illustrates a computer network or similar digital processing environment in which embodiments of the present disclosure may be implemented.

Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60. The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

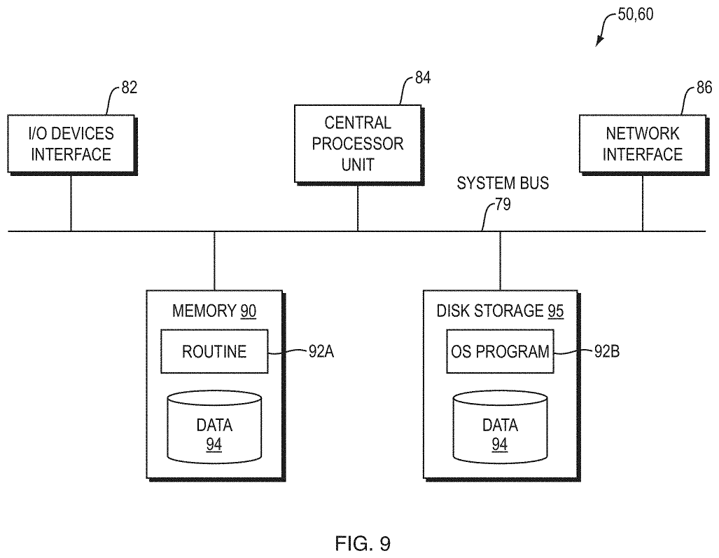

FIG. 9 is a diagram of an example internal structure of a computer (e.g., client processor/device 50 or server computers 60) in the computer system of FIG. 8. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 2). Memory 90 provides volatile storage for computer software instructions 92 and data 94 used to implement an embodiment of the present disclosure. Disk storage 95 provides non-volatile storage for computer software instructions 92 and data 94 used to implement an embodiment of the present disclosure. A central processor unit 84 is also attached to the system bus 79 and provides for the execution of computer instructions.

In one embodiment, the processor routines 92 and data 94 are a computer program product (generally referenced 92), including a non-transitory computer-readable medium (e.g., a removable storage medium such as one or more DVD-ROM's, CD-ROM's, diskettes, tapes, etc.) that provides at least a portion of the software instructions for an embodiment. The computer program product 92 can be installed by any suitable software installation procedure, as is well known in the art. In another embodiment, at least a portion of the software instructions may also be downloaded over a cable communication and/or wireless connection. In other embodiments, the invention programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals may be employed to provide at least a portion of the software instructions for the present invention routines/program 92.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

1. A computer-implemented method for remotely observing an atmospheric condition, the method comprising:
in response to receiving, at one or more fixed antennas, an indication of existence of an airborne aircraft, automatically selecting, at the one or more fixed antennas, an antenna from the one or more fixed antennas based on a location and an orientation of each antenna of the one or more fixed antennas;
using the selected antenna, sending to the Mode S transponder of the aircraft a request for data;
receiving data, at the selected antenna, from the Mode S transponder of the aircraft in response to the request, the data gathered by sensors of the aircraft; and
automatically determining the atmospheric condition based on the data received from the aircraft.

2. The method of claim 1 wherein the atmospheric condition is at least one of:
wind speed;
wind direction;
turbulence; and
temperature.

3. The method of claim 1 wherein the data received from the aircraft includes at least one of:
magnetic orientation of the aircraft;
true air speed of the aircraft;
ground speed of the aircraft;
vertical speed of the aircraft;
location of the aircraft;
Mach of the aircraft; and
track of the aircraft.

4. The method of claim 1, wherein the one or more antennas are a plurality of antennas, the method further comprising determining the orientation of each antenna of the plurality of fixed antennas by:
at each fixed antenna, receiving a plurality of messages from one or more aircrafts, wherein the received messages include aircraft location information;
determining an intensity of each of the plurality of received messages at each of the fixed antennas; and
determining the orientation of each of the fixed antennas based on the location information and the determined intensity of each message of the plurality of received messages at each of the fixed antennas.

5. The method of claim 1 further comprising:
receiving from a sensor the indication of existence of the aircraft.

6. The method of claim 1, further comprising:
associating the atmospheric condition with a location of the aircraft.

7. The method of claim 6, wherein associating the atmospheric condition with the location of the aircraft further includes associating a plurality of atmospheric conditions with respective locations, each respective location being an estimate of the location of the aircraft, and wherein the method further comprises:
storing each of the plurality of atmospheric conditions and respective locations.

8. A system for remotely observing an atmospheric condition, the system comprising:
a processor; and
a memory with computer code instructions stored thereon, the processor and the memory, with the computer code instructions, being configured to cause the system to:
in response to receiving an indication of existence of an airborne aircraft, automatically select, at one or more fixed antennas, an antenna from the one or more fixed antennas based on a location and an orientation of each antenna of the one or more fixed antennas;
send to the Mode S transponder of the aircraft, via the selected antenna, a request for data;
receive data from the Mode S transponder of the aircraft in response to the request; and
automatically process the data received from the aircraft in a manner determining the atmospheric condition.

9. The system of claim 8, wherein the atmospheric condition is at least one of:
wind speed;
wind direction;
turbulence; and
temperature.

10. The system of claim 8, wherein the data received from the aircraft includes at least one of:
magnetic orientation of the aircraft;
true air speed of the aircraft;
ground speed of the aircraft;
vertical speed of the aircraft;
location of the aircraft;
Mach of the aircraft; and
track of the aircraft.

11. The system of claim 8, wherein the one or more fixed antennas are a plurality of fixed antennas, and the instructions further cause the system to:
determine the orientation of each antenna of the plurality of fixed antennas by:
at each fixed antenna, receiving a plurality of messages from one or more aircrafts, wherein the received messages include aircraft location information;
determine an intensity of each of the plurality of received messages at each of the fixed antennas; and
determine the orientation of each of the fixed antennas based on the location information and the determined intensity of each message of the plurality of received messages at each of the fixed antennas.

12. The system of claim 8, wherein the instructions further cause the system to:
receive from a sensor the indication of existence of the aircraft.

13. The system of claim 8, wherein the instructions further cause the system to:
associate the atmospheric condition with a location of the aircraft.

14. The system of claim 13, wherein associating the atmospheric condition with the location of the aircraft further includes associating a plurality of atmospheric conditions with respective locations, wherein the instructions further cause the processor to:
store each of the plurality of atmospheric conditions and respective locations in a database.

15. The system of claim 8, wherein the one or more antennas are a plurality of antennas and wherein selecting the antenna further includes determining an antenna most aligned towards the aircraft based on a location of the aircraft, an orientation of the one or more fixed antenna, and a location of the one or more fixed antenna.

16. A method for determining orientation of an antenna in a plurality of fixed antennas in an environment, the method comprising:
initializing a location of the plurality of fixed antennas in the environment;
at each antenna of the plurality of fixed antennas deployed in the environment, receiving one or more messages from one or more aircraft transmitted by a transponder, the one or more messages including location information for the one or more aircraft;
determining an intensity of each of the received one or more messages at each of the fixed antennas; and
determining an orientation of each of the fixed antennas relative to the environment based on the location information for the one or more aircraft, the location of the plurality of fixed antennas, and the determined intensity of each message of the one or more received messages at each of the fixed antennas.

17. The method of claim 16, further comprising:
in response to receiving, at the one or more fixed antennas, an indication of existence of an airborne aircraft, automatically selecting an antenna from the one or more fixed antennas based on a location and the orientation of each antenna of the one or more fixed antennas;
using the selected antenna, sending to the Mode S transponder of the aircraft a request for data;
receiving data, at the selected antenna, from the Mode S transponder of the aircraft in response to the request, the data gathered by sensors of the aircraft; and
automatically determining an atmospheric condition based on the data received from the aircraft.

18. The method of claim 16, wherein the atmospheric condition is at least one of:
wind speed;
wind direction;
turbulence; and
temperature.

19. The method of claim 16, wherein the data received from the aircraft includes at least one of:
magnetic orientation of the aircraft;
true air speed of the aircraft;
ground speed of the aircraft;
vertical speed of the aircraft;
location of the aircraft;
Mach of the aircraft; and
track of the aircraft.

20. The method of claim 1, wherein selecting the antenna further includes determining an antenna most aligned toward the aircraft based on a location of the aircraft, an orientation of the one or more fixed antenna, and a location of one or more of fixed antenna.
